(19) United States
(12) Patent Application Publication
(10) Pub. No.: US 2022/0023143 A1
(43) Pub. Date: Jan. 27, 2022

(54) Hands-Free Wearable Cardiopulmonary Resuscitation Device

(71) Applicant: Robert C. Glass, JR., Aidie, VA (US)

(72) Inventor: Robert C. Glass, JR., Aidie, VA (US)

(21) Appl. No.: 17/383,018

(22) Filed: Jul. 22, 2021

Related U.S. Application Data
(60) Provisional application No. 63/055,870, filed on Jul. 23, 2020.

(51) Int. Cl. A61H 31/00

(52) U.S. Cl. CPC A61H 31/006; A61H 2230/06; A61H 2201/165; A61H 2201/1621

(57) ABSTRACT

A hands-free wearable cardiopulmonary resuscitation (CPR) device, comprising a wearable belt, an electrical motor mounted on the wearable belt, a piston housing coupled to the wearable belt, and a heartbeat sensor electrically coupled to the electrical motor is provided. The piston housing encloses a piston that is moveably coupled to the electrical motor. The heartbeat sensor is configured to detect an absence of a heartbeat on a user and to responsively activate the electrical motor. The electrical motor is configured to drive the piston to move between upward and downward directions along the piston housing to produce chest compressions on the user in response to the electrical motor being activated by the heartbeat sensor.

### CROSS-REFERENCE TO RELATED PATENT APPLICATIONS

This application claims priority to U.S. Provisional Patent Application No. 63/055,870 filed on Jul. 23, 2020 entitled “A wearable battery-driven piston-on-a-belt for doing hands-free cardiopulmonary resuscitation (CPR),” to the extent allowed by law.

### BACKGROUND OF THE INVENTION

### Field of the Invention

The present disclosure relates to a hands-free, automatic cardiopulmonary resuscitation device.

### Problem to be Solved

Cardiopulmonary resuscitation or CPR is an emergency procedure performed by first responders and bystanders when a person experiences cardiac arrest. When a person's heart and breathing have stopped, performing CPR by applying chest compressions on the person may help save a life by keeping blood and oxygen flowing to the brain and other organs until emergency medical treatment can restore a normal heart rhythm.

While CPR is typically performed by trained persons, remembering the CPR steps and administering them correctly can be a challenge for even trained persons. Further, through no fault of their own, when people's arms get tired from doing CPR, their effectiveness in performing the correct compression frequency and depth of compression degrade, rendering their efforts useless. In such situations, they may need to turn over the CPR activity to another capable bystander, while they rest. If no one else is available, they stop altogether when they are too exhausted to do anymore chest compressions. Existing mechanisms do not support people needing CPR to be performed on them when no one else is able to provide it, because they are alone or in an environment unsafe or unsuitable for others to perform CPR.

Accordingly, there is a need for a hand-free CPR device that can automatically perform chest compressions on people while addressing the above-mentioned problems.

### Description of Prior Art

U.S. Pat. No. 9,789,026 (Hanson) describes a manual cardiopulmonary resuscitation device for delivering chest compressions to a patient needing CPR. The device includes a handle, a deformable housing filled with foam, and a bottom plate. The deformable housing is configured to deform and apply a compressive only force when pressure is applied to the handle. However, U.S. Pat. No. 9,789,026 does not describe a hands-free wearable CPR device that can automatically perform chest compressions on a user as soon as absence of heartbeat is detected on the user.

US 20190321256 (Krewson) describes a portable, hand-holdable mechanical chest compression device that includes a compressor pad and a prime mover to drive the compression pad in an oscillating motion. A responder manually activates the device by holding the device and applying it to an adult human. However, US 20190321256 does not describe a hands-free wearable CPR device that can automatically perform chest compressions on a user as soon as absence of heartbeat is detected on the user.

WO 2013114169 A1 (Kovik) describes a cardiopulmonary resuscitation device that allows a rescuer to perform chest compressions. The device includes a casing which includes handles and a compression box that are connected to each other, so that the downward force applied by the rescuer on the handles is transferred via the lower surface of the device to the patient's chest. However, WO 2013114169 A1 does not describe a hands-free wearable CPR device that can automatically perform chest compressions on a user as soon as absence of heartbeat is detected on the user.

### Statement of the Objects of the Invention

The first objective of the invention is to provide a CPR device that can automatically perform hands-free chest compressions on people experiencing cardiac arrest with a proper frequency and the correct depth. The second objective of the invention is to automatically initiate the application of chest compressions on a person as soon as no heartbeat is detected and to continue doing proper chest compressions until a heartbeat is again detected on the person. The third objective of the invention is to allow CPR to be automatically performed on persons who live alone or in an environment unsafe or unsuitable for others to perform CPR. The fourth objective of the invention is to provide CPR on a person sitting on a commercial plane that is experiencing heavy turbulence. The fifth objective of the invention is to provide CPR on seated, supine, or prone persons including those persons lying on their side. The sixth objective of the invention is to provide a device that would automatically initiate and continue to do CPR on a conscious or unconscious victim (e.g., a lone hunter, fisherman, hiker, or even a lone elderly person needing CPR) whose heart suddenly stops beating.

### SUMMARY OF THE INVENTION

One embodiment provides a hands-free wearable cardiopulmonary resuscitation (CPR) device, comprising a wearable belt, an electrical motor mounted on the wearable belt, a piston housing coupled to the wearable belt, and a heartbeat sensor electrically coupled to the electrical motor. The piston housing encloses a piston that is moveably coupled to the electrical motor. The heartbeat sensor is configured to detect an absence of a heartbeat on a user and to responsively activate the electrical motor. The electrical motor is configured to drive the piston to move between upward and downward directions along the piston housing to produce chest compressions on the user in response to the electrical motor being activated by the heartbeat sensor.

Another embodiment provides a method comprising: securing a wearable belt to a body of a user, the wearable belt attached to a piston housing that houses a piston; detecting, via a heartbeat sensor coupled to the wearable belt, an absence of a heartbeat on a user, and responsively activating an electrical motor placed in the wearable belt; and driving the piston that is moveably coupled to the electrical motor to move between upward and downward directions along the piston housing to produce chest compressions on the user in response to activating the electrical motor.

A further embodiment provides a hands-free wearable cardiopulmonary resuscitation (CPR) device, comprising: a wearable belt configured to be worn on the chest of a user; an electrical motor mounted on the wearable belt; a piston housing coupled to the wearable belt, the piston housing enclosing a piston that is moveably coupled to the electrical motor; and a switch electrically coupled to the electrical motor, the switch configured to activate the electrical motor when the switch is transitioned from an off-state to an on-state. The electrical motor is configured to drive the piston to move between upward and downward directions along the piston housing to produce chest compressions on the user in response to the electrical motor being activated by the switch.

### A BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a hands-free wearable cardiopulmonary resuscitation device in accordance with some embodiments.

FIG. 2 is a circuit diagram illustrating the connections between different components of the hands-free wearable cardiopulmonary resuscitation device in accordance with some embodiments.

FIG. 3 is a top plan view of the hands-free wearable cardiopulmonary resuscitation device illustrating a belt portion of the device in an unsecured position in accordance with some embodiments.

FIG. 4 is a front elevation view of a hands-free wearable cardiopulmonary resuscitation device illustrating a belt portion of the device in a secured position in accordance with some embodiments.

FIG. 5A is a cross-sectional front view of the hands-free wearable cardiopulmonary resuscitation device illustrating an initial position of a piston in accordance with some embodiments.

FIG. 5B is a cross-sectional front view of the hands-free wearable cardiopulmonary resuscitation device illustrating an operational position of the piston in accordance with some embodiments.

FIG. 6 is a cross-sectional schematic side view illustrating components of a piston housing of a hands-free wearable cardiopulmonary resuscitation device in accordance with some embodiments

FIG. 7 is a perspective view illustrating a hands-free wearable cardiopulmonary resuscitation device disposed on a compression shirt in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE ILLUSTRATED EMBODIMENTS

Each of the above-mentioned embodiments will be discussed in more detail below, starting with an example structure of a hands-free wearable cardiopulmonary resuscitation (CPR) device in which the embodiments may be practiced, followed by an illustration of various views of the device. Further advantages and features consistent with this disclosure will be set forth in the following detailed description, with reference to the figures.

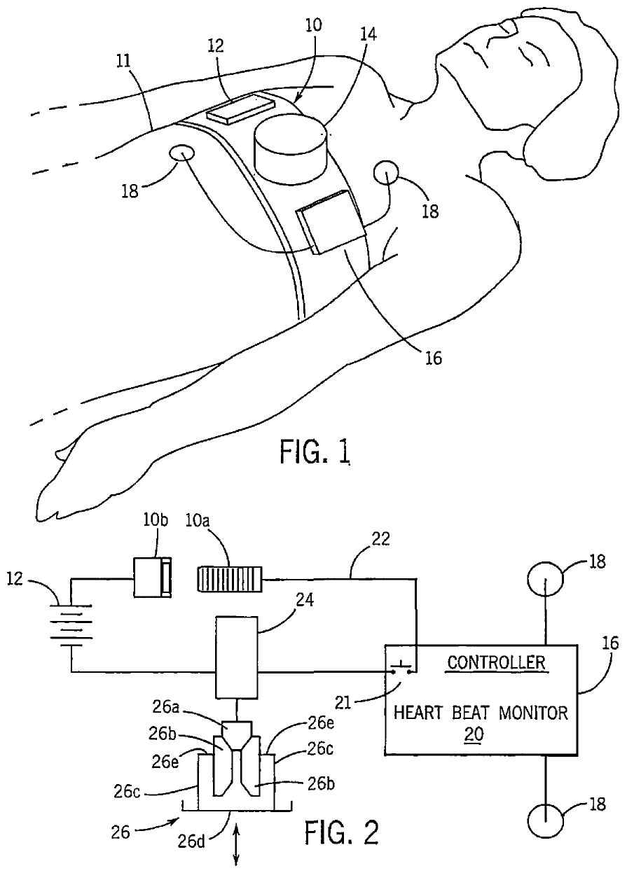

Referring now to the drawings, and in particular FIG. 1, a perspective view of a hands-free wearable cardiopulmonary resuscitation (CPR) device is shown. The hands-free wearable CPR device includes a wearable belt 10 configured to be worn on the chest of a user 11, an electrical power source 12, a piston housing 14, and a heartbeat sensor or monitor 16 including one or more sensor leads 18 that are configured to be placed on the chest of the user 11 to detect the absence of a heartbeat on the user 11. In operation, the belt 10 is put under an unconscious user 11 and further the belt 10 is tightened until it is snug on the user 11. The belt 10 is preferably placed directly on the chest centered on the bottom of the sternum. One sensor lead 18 may be placed on the upper left of the chest of the user 11, directly on the skin and the other sensor lead 18 may be placed on the lower right of the chest of the user 11, directly on the skin as well. In one embodiment, the CPR device includes an alarm (not shown), for example, a light or a sound alarm attached to the wearable belt 10. The alarm is configured to provide an alarm when the one or more sensor leads 18 are not in contact with a body of the user 11. The CPR device is designed to enable the users 11 to attach the device themselves when they are conscious. The CPR device is activated when a belt buckle engages the belt 10. In accordance with some embodiments, once activated, the CPR device monitors, via the heartbeat sensor 16 and the sensor leads 18, for presence or absence of heartbeat on the user 11. When the CPR device detects an absence of heartbeat on the user 11 via the heartbeat sensor 16 and the sensor leads 18, the CPR device automatically produces chest compressions on the user 11 by moving a piston 26 (FIG. 2) enclosed in the piston housing 14 between upward and downward directions to push the piston 26 into the chest of the user 11 until heartbeat is again detected on the user 11. When the CPR device detects a presence of heartbeat on the user 11 while the chest compressions are being produced, the CPR device automatically stops producing chest compressions on the user 11 by stopping the movement of the piston 26 enclosed in the piston housing 14.

Now referring to FIG. 2, a circuit diagram is shown illustrating the connections between different components of the hands-free wearable CPR device. The wearable belt 10 includes a belt strap or ratchet strap 10a and a belt buckle 10b. The belt strap 10a is removably securable to the belt buckle 10b. An electrical motor 24 is disposed on the CPR device. The electrical motor 24 may be mounted on the wearable belt 10. In one embodiment, the electrical motor 24 is mounted on top of the piston housing 14. The electrical power source 12 includes one or more rechargeable or replaceable batteries that are operatively controlled by the heartbeat sensor 16 to supply power to the electrical motor 24 for activating the electrical motor 24 in response to detecting an absence of a heartbeat on the user 11. An electrical wire 22 runs through a length of the wearable belt 10 to transmit power from the electrical power source 12 to the electrical motor 24 for activating and operating the electrical motor 24. The belt strap 10a and belt buckle 10b each may have one or more electrical contacts that are arranged to contact each other when the belt strap 10a is secured to the belt buckle 10b. In one embodiment, the CPR device is automatically activated to monitor for presence or absence of heartbeats on the user 11 via the heartbeat sensor 16 when the belt strap 10a is secured to the belt buckle 10b. The heartbeat sensor 16 has a controller 20 that controls an electrical switch 21 to transition between an off-state and an on-state. In the off-state, the electrical switch 21 remains open with no electrical connection established between the electrical power source 12 and the electrical motor 24. thereby disabling or deactivating the operation of the electrical motor 24. In the on-state, the electrical switch 21 is closed to establish an electrical connection between the electrical power source 12 and the electrical motor 24 via the electrical wire 22, thereby enabling or activating the operation of the electrical motor 24. In accordance with embodiments, the controller 20 of the heartbeat sensor 16 controls the switch 21 to transition from an off-state to an on-state when the heartbeat sensor 16 detects, via the sensor leads 18, an absence of a heartbeat on the user 11. In other words, the electrical motor 24 is automatically activated or operated when no heartbeat is detected on the user 11.

In accordance with some embodiments, the controller 20 of the heartbeat sensor 16 may comprise an electronic processor (for example, a microprocessor, a logic circuit, an application-specific integrated circuit, a field-programmable gate array, or another electronic device), volatile memory, nonvolatile memory such as electrically erasable programmable read-only memory (EEPROM) for storing programming, and nonvolatile storage, e.g., flash memory, for storing firmware and operational parameters. The memory of controller 20 may store program instructions that, when executed by the electronic processor of the controller 20, cause the electronic processor to control the switch 21 the transition from an off-state to an on-state when an absence of heartbeat is detected on the user 11. Similarly, the memory of controller 20 may store program instructions that, when executed by the electronic processor of the controller 20, cause the electrical processor to control the switch 21 to transition from an on-state to an off-state when presence of heartbeat is detected on the user 11.

As further shown in FIG. 2, a gear, for example, a circular bevel gear 26a is rotatably attached to the electrical motor 24 at one end and further operatively connected to one or more further gears, for example, oblong gears 26b at the other end. The oblong gears 26b are attached to connecting rods 26c via respective attachments 26e. The connecting rods 26c are attached to the oblong gears 26b at one end and to a piston 26 at the other end. The piston 26 includes a piston head 26d that is configured to make contact with the chest of the user 11 when the belt 10 is secured to the user 11.

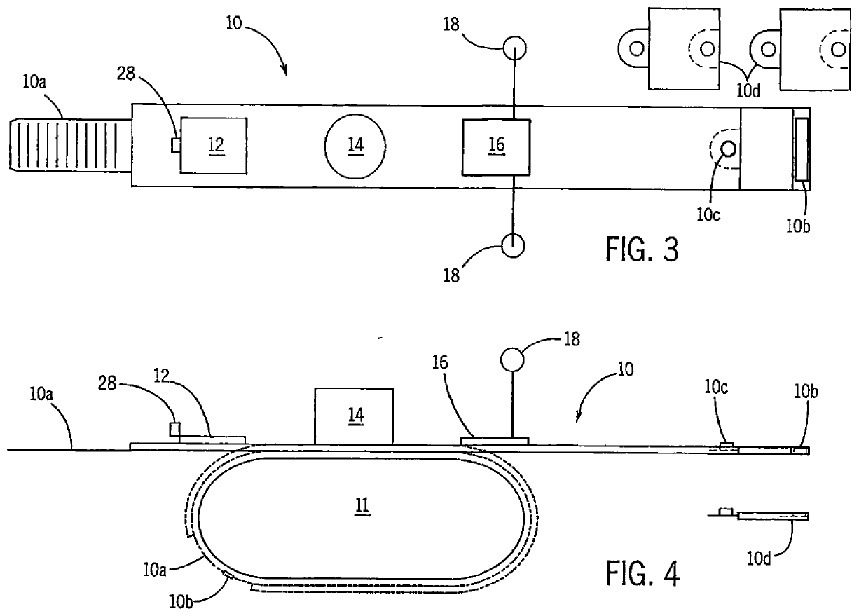

FIG. 3 shows a top plan view of the hands-free wearable cardiopulmonary resuscitation device illustrating a belt portion of the device in an unsecured position in accordance with some embodiments. As shown in FIG. 3, the wearable belt 10 includes a belt strap 10a that is securable to a belt buckle 10b. Additional modular straps 10c, 10d may be disposed at the belt 10 for securing the belt 10 to the user 11. In FIG. 3, the wearable belt 10 is shown as not being secured to the user 11. The wearable belt 10 includes an electrical power source 12, a piston housing 14, and a heartbeat sensor 16 that are disposed on different areas of the wearable belt 10. The heartbeat sensor 16 is attached to the sensor leads 18. The electrical power source 12 is coupled to a receptacle 28 such as a universal serial bus (USB) port for charging the electrical power source 12. The electrical power source 12 may include one or more rechargeable or replaceable batteries. The placement of the electrical power sources 12 and the heartbeat sensor 16 could be interchanged.

FIG. 4 is a front elevation view of a hands-free wearable cardiopulmonary resuscitation device illustrating a belt portion of the device in a secured position relative to a user 11 in accordance with some embodiments. As shown in FIG. 4, the electrical power source 12, piston housing 14, heartbeat sensor 16, belt strap 10a, belt buckle 10b, modular straps 10c are disposed at different sections along the length of the wearable belt 10. The piston housing 14 is positioned in a recess formed in the wearable belt 10. The recess is configured to align with the chest of the user 11 when the wearable belt 10 is secured to the user 11. The piston housing 14 is securely positioned in the recess formed in the wearable belt 10. The piston 26 is configured to contact the chest of the user 11 while the piston 26 is moving between upward and downward directions to produce chest compressions on the user 11. In one embodiment, a light indicator is added to the hands-free wearable CPR device, for example, on top of the piston housing 14 to show an amount of charge left in the electrical power source 12. In addition, an audible battery alarm indicating a charge is necessary could be installed in the CPR device.

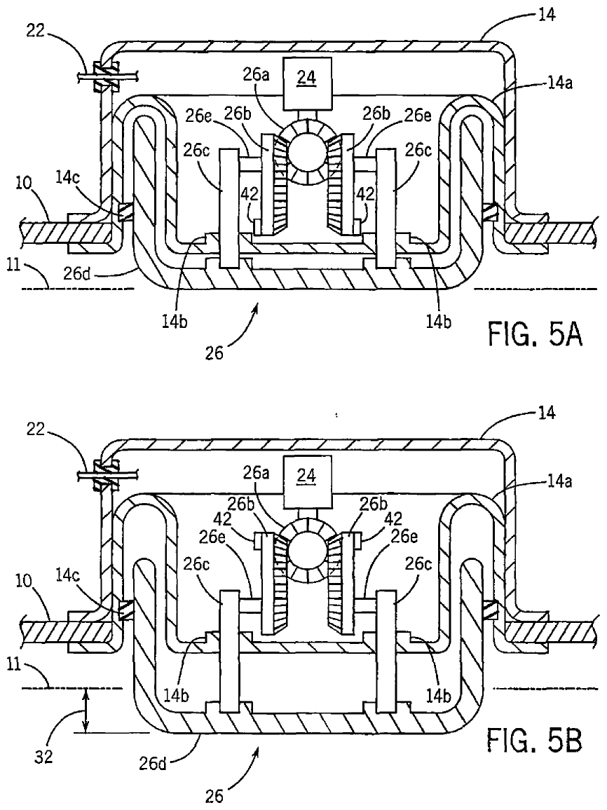

FIG. 5A is a cross-sectional front view of the hands-free wearable cardiopulmonary resuscitation device illustrating an initial position of a piston enclosed in a piston housing in accordance with some embodiments. The piston housing 14 is disposed in the wearable belt 10 such that piston 26 enclosed in the piston housing 14 makes contact with the chest of the user 11 at the initial position when the belt 10 is secured to the user. As shown in FIG. 5A, the piston 26 remains at the initial position when the piston 26 is not driven by the electrical motor 24. The piston housing 14 may be made of plastic material. The piston may be made of silicon, rubber, or another non-conductive material. In one embodiment, the piston 26 and piston housing 14 are made of stainless steel to provide strength and durability. An oil reservoir (not shown) could be added to lubricate the piston and piston housing. Further, a thin replaceable liner or cushion (not shown) could be attached to the piston 26 for user's comfort and sanitation.

In one embodiment. an electrical motor 24 is positioned on the top of the piston housing 14. In another embodiment. the electrical motor 24 is mounted on the side of the piston housing 14 using bevel gears to operate the piston 26. The electrical motor 24 is shown in FIG. 5A as rotatably attached to a circular bevel gear 26a. The circular bevel gear 26a is further rotatably attached to two oblong gears 26b on either end. Each of the oblong gears 26b is further connected to the piston 26 via respective connecting rods 26c and respective attachments 26e. Each of the oblong gears 26b may be further attached to a counterbalance weight 42 to reduce vibration when the piston 26 moves up and down during its operation. Bushings 14c or a thin brush lining may be added between the piston 26 and the piston housing 14 to prevent dirt from getting along the piston housing 14.

FIG. 5B is a cross-sectional front view of the hands-free wearable cardiopulmonary resuscitation device illustrating an operational position of the piston 26 in accordance with some embodiments. When the wearable belt 10 is placed around the user 11 and the belt buckle 10b is secured, the CPR device's electric circuit remains open and there is no electrical connection between the electrical power source 12 and electrical motor 24. The wearable belt 10 connects the piston head 26d of the piston 26 to the chest of the user 11 and keeps the piston head 26d in place while the piston 26 is operated by the electrical motor 24 to move up and down. In accordance with embodiments, when the sensor leads 18 attached to the chest of the user 11 detect the absence of a heartbeat on the user 11, the sensor leads 18 send a signal to the heartbeat sensor 16. The controller 20 of the heartbeat sensor 16 closes the device's electrical circuit by controlling the switch 21 to transition from an off-state to an on-state. In the on-state, the switch 21 is closed to establish an electrical connection between the electrical power source 12 and the electrical motor 24. When the electrical motor 24 is activated by power from the electrical power source 12, the electrical motor 24 rotates and causes the circular bevel gear 26a attached to the electrical motor 24 to rotate. In accordance with some embodiments, the small circular gear 26a and the large oblong gears 26b are bevel gears, i.e., they are operatively connected ninety degrees to each other. The rotation of the circular bevel gear 26a causes the oblong gears 26b to rotate. The oblong gears 26b are attached to the connecting rods 26c and to counterbalance weights 42. The rotating oblong gears 26b cause the connecting rods 26c to go up and down, which in turn drives the piston 26 to go up and down or to move continuously (until electrical motor 24 is deactivated) between upward and downward directions. The counterbalance weights 42 reduce vibration while the piston 26 moves up and down. The piston head 26d may push or move down or up to a predetermined distance 32 as shown in FIG. 5B. For example, the piston 26 may be configured to push two (2) inches into the chest of the unconscious user, compressing the heart at a frequency of hundred and fifteen (115) beats per minute. In one embodiment, a timer indicating total time duration of compressions is included in the CPR device.

When the heartbeat sensor leads 18 detect a heartbeat at any time while the piston 26 is moving up and down, the sensor leads 18 send a signal to the heartbeat sensor 16 indicating the presence of heartbeat on the user 11. The controller 20 of the heartbeat sensor 16 opens the device's electrical circuit by controlling the switch 21 to transition from an on-state to an off-state. In the off-state, the switch 21 is opened to break the electrical connection between the electrical power source 12 and the electrical motor 24, thereby disabling the operation of the electrical motor 24. The electrical motor 24 then stops rotating and causes the piston 26 to also stop its up and down movement. In one embodiment, a timer is included in the CPR device to indicate the length of time the heartbeat has been beating on its own after CPR was performed. In other words, the timer indicates a length of time since presence of a heartbeat has been detected subsequent to the chest compressions produced by the CPR device.

For instance, when the heart stops beating again, the sensor leads 18 will detect this and send a signal to the heartbeat sensor 16. In this case, the device's electric circuit will be again closed to activate the electrical motor 24 in order to initiate chest compressions again by moving the piston 26 up and down. One or more one-way air valves (not shown) may be disposed in the piston housing 14 to cool the electrical motor 24 and to prevent suction. In another embodiment, instead of one-way valves, vents could be placed on the piston housing 14 for heat dissipation and cooling. In one embodiment, a replaceable sanitary lining could be attached to the inside of the belt 10 for the comfort of the user 11 wearing the belt 10 for long periods of time.

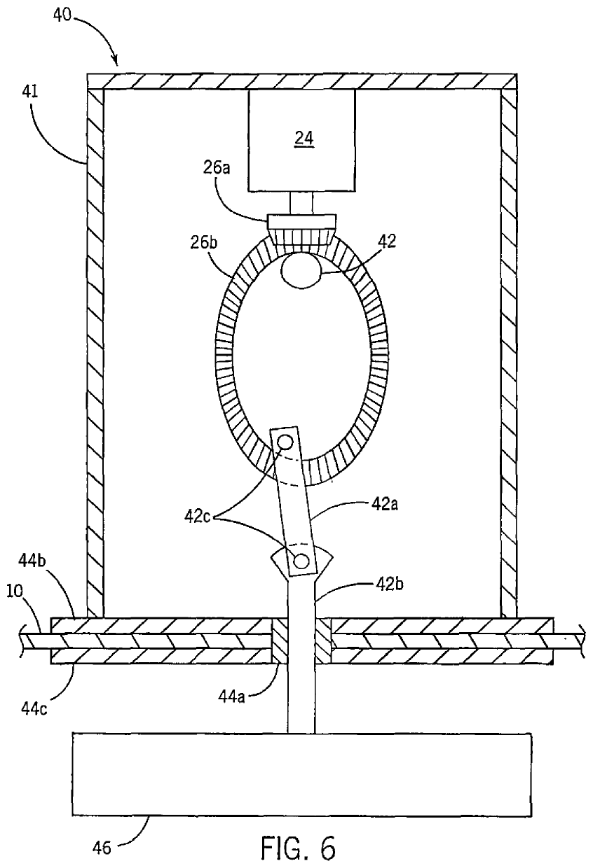

FIG. 6 is a cross-sectional schematic side view illustrating components of a piston housing of a hands-free wearable cardiopulmonary resuscitation device in accordance with some embodiments. The CPR device shown in FIG. 6 includes a piston housing 40 (similar to piston housing 14 shown in FIGS. 5A and 5B) including a side edge 41 and bottom edges 44b, 44c. A portion of the wearable belt 10 is secured between the bottom edges 44b, 44c of the piston housing 40 that is coupled to the wearable belt 10. The electrical motor 24 is further shown as rotatably coupled to a circular bevel gear 26a which in turn is rotatably coupled to the oblong gears 26b. Pins 42c connect the connecting rod 42a (similar to the connecting rod 26c shown in FIGS. 5A and 5B) to oblong gear 26b at one end and to a piston rod 42b of a piston 26 at the other end. The piston rod 42b is moveably secured within a recess or spacing 44a formed by the belt 10 and piston housing 40. The piston rod 42b is connected to a piston head 46 (similar to the piston head 26d shown in FIGS. 5A and 5B) which moves up and down in a similar manner as described with reference to FIG. 5B. The oblong gear 26b is attached to a counterbalance weight 42 to reduce vibration during the movement of the piston head 46 coupled to the piston rod 42b.

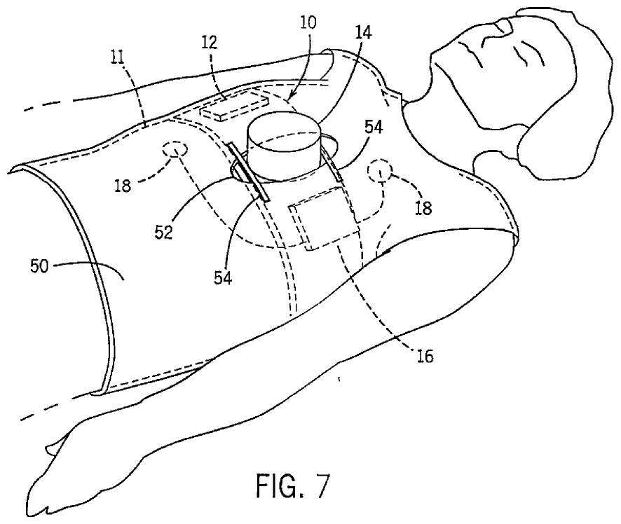

FIG. 7 is a perspective view illustrating a hands-free wearable cardiopulmonary resuscitation device disposed on a compression shirt in accordance with some embodiments. The compression shirt 50 is configured to be worn on the user and to keep the sensor leads 18 in place. The compression shirt 50 is also configured to keep the entire CPR device in its correct position for conscious, active user 11. The compression shirt 50 may be worn by users needing to perform CPR on themselves either because they live alone or live in an environment unsafe or unsuitable for others to perform CPR. The compression shirt 50 also keeps the piston housing 14 in the optimum position with hook and loop strips 54, for example, one strip 54 on the top and the other at the bottom. The compression shirt 50 prevents the CPR device from slipping out of optimal position.

In accordance with some embodiments, the CPR device can be used as a compliment to an automated external defibrillator (AED) to increase the survivability of victims of cardiac arrest. AEDs come into play after CPR is done on the user 11. The CPR device provides CPR to initiate the heart beating on the user 11, and then an AED could be used to determine if the rhythm is correct. For example, when a user 11 wearing the compression shirt 50 with the belt 10 falls unconscious, a bystander may attach an AED to the user 11. The compression shirt 50 has an open vertical slit 52 corresponding to the location of the piston housing 14. The AED's paddles may be inserted into the open vertical slit 52. The devices' heartbeat sensor leads 18 detect whether or not a heartbeat exists on the user 11. If there is a heartbeat, the device's piston 26 will remain inactive. The AED may be used to analyze the heartbeat. In one embodiment, the AED may be used to deliver an electric shock via its paddles to correct the heartbeat pattern to a life-sustaining heartbeat. If no heartbeat is detected, the CPR device will do heart compressions until the heartbeat sensors leads 18 detect a heartbeat. In this case, the AED may be again used to analyze the heartbeat and to provide shock to the user 11, if necessary. The CPR device and the AED are stand-alone devices that can be used simultaneously without interference to the ability of either of the devices to do their proper function.

In one embodiment, the heartbeat sensor 16 can be replaced with a resistor switch (not shown) to connect or disconnect the electrical connection between the electrical power source 12 and the electrical motor 24. In this embodiment, the hands-free wearable CPR device similarly comprises a wearable belt 10 configured to be worn on the chest of a user 11, an electrical motor 24, a piston housing 14 coupled to the wearable belt 10, and a switch electrically coupled to the electrical motor 24. The switch is configured to activate the electrical motor 24 when the switch is transitioned from an off-state to an on-state. For example, the switch may be manually controlled by the user 11 or alternatively by a bystander when the user 11 is unconscious. The piston housing 14 encloses a piston 26 that is moveably coupled to the electrical motor. Further, the electrical motor 24 is configured to drive the piston 26 to move between upward and downward directions along the piston housing 14 to produce chest compressions on the user 11 in response to the electrical motor 24 being activated by the switch. The switch is further configured to deactivate the electrical motor 24 when the switch is transitioned from the on-state to off-state (when heartbeat is again detected) to stop the piston 26 from moving between the upward and downward directions.

In accordance with some embodiments, the hands-free wearable CPR device may include a global positioning system (GPS) unit (not shown) or a transponder attached to the wearable belt 10. The GPS unit is configured to send a notification indicating a GPS location of the user 11 to designated people. In one embodiment, the notification indicating the GPS location of the user may be sent to designated people when no heartbeat is detected on the user 11. In accordance with some embodiments, the hands-free wearable CPR device further includes a recording device (not shown) attached to the wearable belt. The recording device stores information for first responders indicating when the hands-free wearable CPR device was activated, a length of time the hands-free wearable CPR device has been activated, and designated people who have been notified about the absence of heartbeat on the user 11.

The foregoing description of the illustrated embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A hands-free wearable cardiopulmonary resuscitation (CPR) device, comprising:
a wearable belt;
an electrical motor mounted on the wearable belt;
a piston housing coupled to the wearable belt, the piston housing enclosing a piston that is moveably coupled to the electrical motor;
a heartbeat sensor electrically coupled to the electrical motor, the heartbeat sensor configured to detect an absence of a heartbeat on a user and to responsively activate the electrical motor; and
the electrical motor configured to drive the piston to move between upward and downward directions along the piston housing to produce chest compressions on the user in response to the electrical motor being activated by the heartbeat sensor.

2. The hands-free wearable CPR device of claim 1, wherein the heartbeat sensor is further configured to detect a presence of a heartbeat on the user and to responsively deactivate the electrical motor and stop the piston from moving between the upward and downward directions.

3. The hands-free wearable CPR device of claim 1, wherein the wearable belt is configured to be worn on the chest of the user.

4. The hands-free wearable CPR device of claim 1, further comprising:
a recess formed in the wearable belt, the recess configured to align with the chest of the user when the wearable belt is worn by the user, the piston housing securely positioned in the recess formed in the wearable belt, the piston configured to contact the chest of the user while the piston is moving between upward and downward directions to produce chest compressions on the user.

5. The hands-free wearable CPR device of claim 1, wherein the wearable belt includes a belt buckle and a belt strap, the belt strap removably securable to the belt buckle.

6. The hands-free wearable CPR device of claim 5, further comprising:
a first electrical contact placed in the belt strap; and
a second electrical contact placed in the belt buckle,
the first and second electrical contacts contacting each other when the belt strap is secured to the belt buckle.

7. The hands-free wearable CPR device of claim 6, further comprising:
an electrical power source disposed within the wearable belt, the electrical power source electrically coupled to the first and second electrical contacts when the first and second electrical contacts are in contact with each other, the electrical power source operatively controlled by the heartbeat sensor, the electrical power source configured to supply power to the electrical motor and to activate the electrical motor in response to detecting the absence of the heartbeat on the user.

8. The hands-free wearable CPR device of claim 1, further comprising:
a circular bevel gear housed in the piston housing, the circular bevel gear rotatably attached to the electrical motor;
at least one oblong gear housed in the piston housing, the at least one oblong gear operatively connected to the circular bevel gear; and
at least one connecting rod housed in the piston housing, the at least one connecting rod attached to the at least one oblong gear at one end and to the piston at another end.

9. The hands-free wearable CPR device of claim 8, wherein upon being electrically activated by the heartbeat sensor, the electrical motor rotates and causes the circular bevel gear and the at least one oblong gear operatively connected to the circular bevel gear to rotate, causing the at least one connecting rod and the piston attached to the at least one connecting, rod to move between upward and downward directions.

10. The hands-free wearable CPR device of claim 9, wherein the at least one oblong gear is attached to at least one counterbalance weight, the at least one counterbalance weight reducing vibration while the piston is moving between upward and downward directions.

11. The hands-free wearable CPR device of claim 1, wherein the heartbeat sensor is communicatively coupled to one or more heartbeat sensor leads, the heartbeat sensor leads configured to be placed on the chest of the user to detect the absence of a heartbeat on the user.

12. The hands-free wearable CPR device of claim 11, further comprising:
an alarm attached to the wearable belt, the alarm configured to provide an alarm when the one or more sensor leads are not in contact with a body of the user.

13. The hands-free wearable CPR device of claim 1, further comprising:
a timer attached to the wearable belt, the timer configured to indicate one or more of a total time duration of the chest compressions produced on the user and a length of time since presence of a heartbeat has been detected on the user subsequent to the chest compressions.

14. The hands-free wearable CPR device of claim 1, further comprising:
a global positioning system (GPS) unit attached to the wearable belt, the GPS unit configured to send a notification indicating a GPS location of the user to designated people.

15. The hands-free wearable CPR device of claim 1, further comprising:
a recording device attached to the wearable belt, the recording device storing information for first responders, the information indicating when the hands-free wearable CPR device was activated, a length of time the hands-free wearable CPR device has been activated, and designated people who have been notified about the absence of heartbeat on the user.

16. The hands-free wearable CPR device of claim 1, further comprising:
a compression shirt housing the wearable belt, the piston housing, the electrical motor, and the heartbeat sensor, the compression shirt having a vertical slit corresponding to the location of the piston housing.

17. A method, comprising:
securing a wearable belt to a body of a user, the wearable belt attached to a piston housing that houses a piston;
detecting, via a heartbeat sensor coupled to the wearable belt, an absence of a heartbeat on a user, and responsively activating an electrical motor placed in the wearable belt; and
driving the piston that is moveably coupled to the electrical motor to move between upward and downward directions along the piston housing to produce chest compressions on the user in response to activating the electrical motor.

18. The method of claim 17, further comprising:
detecting, via the heartbeat sensor, a presence of a heartbeat on the user, and responsively deactivating the electrical motor to stop the piston from moving between the upward and downward directions.

19. A hands-free wearable cardiopulmonary resuscitation (CPR) device, comprising:
a wearable belt configured to be worn on the chest of a user;
an electrical motor mounted on the wearable belt;
a piston housing coupled to the wearable belt, the piston housing enclosing a piston that is moveably coupled to the electrical motor;
a switch electrically coupled to the electrical motor, the switch configured to activate the electrical motor when the switch is transitioned from an off-state to an on-state; and
the electrical motor configured to drive the piston to move between upward and downward directions along the piston housing to produce chest compressions on the user in response to the electrical motor being activated by the switch.

20. The hands-free wearable cardiopulmonary resuscitation (CPR) device of claim 19, wherein the switch is configured to deactivate the electrical motor when the switch is transitioned from the on-state to off-state to stop the piston from moving between the upward and downward directions.
